(19) United States
(12) Patent Application Publication
(10) Pub. No.: US 2012/0166004 A1
(43) Pub. Date: Jun. 28, 2012

(54) ENERGY MANAGEMENT SYSTEM IN HOME NETWORK INTERWORKING WITH SMART GRID

(75) Inventors: Wan Ki PARK, Daejeon (KR); IL WOO LEE, Daejeon (KR); JINSOO HAN, Daejeon (KR)

(73) Assignees: KT Corporation, Seongnam-si (KR); Electronics and Telecommunications Research Institute, Daejeon (KR)

(21) Appl. No.: 13/335,164

(22) Filed: Dec. 22, 2011

(30) Foreign Application Priority Data
Dec. 23, 2010 (KR) 10-2010-0133778

(51) Int. Cl. G06F 1/28

(52) U.S. Cl. 700/291; 700/295; 700/296

(57) ABSTRACT

An energy management system in a home network interworking with a smart grid includes: a power management apparatus for managing power consumption of a power consumption apparatus; a power storage apparatus for storing or supplying power to the power consumption apparatus; a power production apparatus for transmitting status information of its power production to the power management apparatus; a mobile power storage/supply apparatus for transmitting its power status to the power management apparatus; a smart meter for transmitting a real-time price and demand response information to the power management apparatus; and a wireless terminal for inputting a schedule of a home power consumer.

### CROSS-REFERENCE(S) TO RELATED APPLICATION(S)

The present invention claims priority of Korean Patent Application No. 10-2010-0133778, filed on Dec. 23, 2010, which is incorporated herein by reference.

### FIELD OF THE INVENTION

The present invention relates to a technology for home energy management in a smart grid in which power is combined with communications; and, more particularly, to an energy management system in a home network interworking with a smart grid, which is suitable for providing optimized operation of home energy by interworking with a smart grid.

### BACKGROUND OF THE INVENTION

The general power system environment so far has had a unilateral flow from production to transmission, and to consumer. In such an environment, an optimal method of saving energy is to minimize the power consumption of each of power consumption devices.

However, in a smart grid environment which has newly appeared owing to the recent combination of power technology with communication information technology, a consumer is no longer just a unilateral consumer and may provide an environment for home power production and storage. Also, the use of electric vehicles will be an issue in the near future.

Thus, it is necessary to introduce an energy management method which is capable of optimizing the use of energy in point of consumers while considering power price which may fluctuate in real time.

Further, there is also required an energy management technology which can provide efficient energy usage measures with the amount of power consumed by each of power consumption devices by using a home network technology being used in a digital home environment.

### SUMMARY OF THE INVENTION

In view of the above, the present invention provides an energy management technology in a home network interworking with a smart grid, which is capable of efficiently managing energy usage in point of a consumer by performing integral management in such a way as to carry out the functions of monitoring and controlling the power consumption status of a power consumption device and the status of a power storage/production apparatus while taking into consideration lifestyle patterns and plans of the consumer, and a real-time power price.

In accordance with a first aspect of the present invention, there is provided an energy management system in a home network interworking with a smart grid, including:

a power management apparatus for managing power consumption of a power consumption apparatus within the home network and managing a power usage based on a real-time price in the home network and demand response information in a power network;

a power storage apparatus for storing power therein or supplying power stored therein to the power consumption apparatus under a control of the power management apparatus;

a power production apparatus for transmitting status information of its power production to the power management apparatus such that the information is used for power management of the power management apparatus;

a mobile power storage/supply apparatus for transmitting its power status to the power management apparatus such that the power status is used for power management of the power management apparatus;

a smart meter for transmitting the real-time price and the demand response information to the power management apparatus; and

a wireless terminal for inputting a usage plan of the mobile power storage/supply apparatus and a schedule of a home power consumer.

In accordance with a second aspect of the present invention, there is provided a power management apparatus in a home network interworking with a smart grid, including:

a power integration management unit for controlling a power storage apparatus and a mobile power storage/supply apparatus, and one or more power consumption apparatuses in the home network according to a home power management algorithm;

a network interface unit for transmitting an instruction, which is given by the power integration management unit, of collecting or controlling power information to outside via a wired or wireless communication network;

a power storage/supply control unit for performing control and management such that power is stored to or supplied from the mobile power storage/supply apparatus based on information received through the network interface unit;

a power consumption control unit for controlling power consumption of the power consumption apparatuses based on power control information generated by the power integration management unit;

a power storage status management unit for managing an amount of power stored in the power storage apparatus, and managing a storage of power to or a supply of power from the power storage apparatus; and

a power production status management unit for managing real-time power production status of a power production apparatus to transmit the managed real-time power production status to the power integration management unit.

In accordance with a third aspect of the present invention, there is provided a power management method in a home network interworking with a smart grid in which a power network and a communication network coexist, the method including:

collecting schedule plans of users within the home network;

estimating power consumption in a home under consideration of the collected schedule plans;

estimating a directionality of real-time price fluctuations by analyzing a price trend based on real-time price which is received via the communication network;

calculating an average price for a long time period and for a short time period based on the real-time price;

calculating a time period for which power can be supplied from a power storage apparatus connected to the power network;

calculating an estimated amount of power to be produced by a power production apparatus connected to the power network;

classifying one or more power consumption apparatuses connected to the power network depending on importance of each of the power consumption apparatuses;

analyzing utilizability of a power supply from a mobile power storage/supply apparatus connected to the power network while taking into consideration an operational plan of the mobile power storage/supply apparatus;

determining a power management schedule by controlling and managing a power operation of the power storage apparatus, the power consumption apparatuses, and the mobile power storage/supply apparatus; and

providing controlling power for each of power consumption apparatuses, the power storage apparatus, power production apparatus and the mobile power storage/supply apparatus according to the determined power management schedule.

### BRIEF DESCRIPTION OF THE DRAWINGS

The objects and features of the present invention will become apparent from the following description of embodiments, given in conjunction with the accompanying drawings, in which:

FIG. 1 is a block diagram illustrating a energy management system in a home network interworking with a smart grid in accordance with an embodiment of the present invention;

FIG. 2 is a block diagram illustrating a power management apparatus in the home network interworking with a smart grid in accordance with the embodiment of the present invention; and

FIG. 3 is a flowchart exemplarily illustrating a power management method in the home network interworking with a smart grid in accordance with the embodiment of the present invention.

### DETAILED DESCRIPTION OF THE PREFERRED EMBODIMENTS

The present invention relates to a technology for an apparatus capable of providing an efficient power energy usage environment by considering the power consumption of power consumption devices and the operational statuses thereof, the lifestyle plan of a user, and the power statuses of household smart equipments when integrally managing a home power storage apparatus, a home power production apparatus, a power storage/supply apparatus such as an electric vehicle, and the power consumption devices such as electrical appliances and lighting and heating devices, which exist in the home environment. Further, the present invention relates to a method of managing and controlling power using the technology.

The above-described present invention provides a function of optimizing the power consumption of digital home power consumption apparatuses in point of a consumer by connecting a control of the operational modes of the home power consumption apparatuses with a control of a home power storage apparatus and a mobile power storage/supply apparatus, based on collected energy information, a real-time price, the power status information of the home power storage apparatus and a home power production apparatus, the status information of the mobile power storage/supply apparatus, information about a lifestyle pattern and schedule plan of a user and a real-time price pattern.

Hereinafter, embodiments of the present invention will be described with reference to the accompanying drawings which form a part hereof.

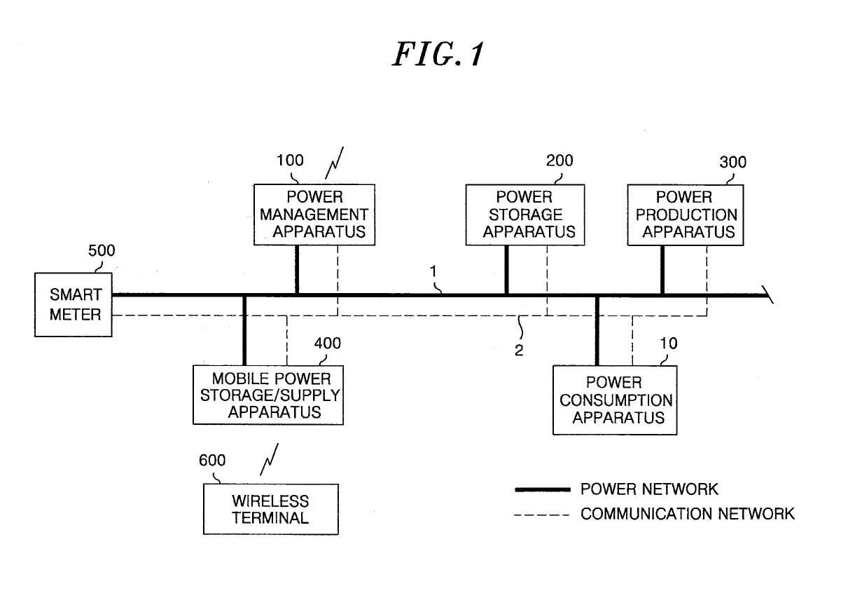

FIG. 1 is a block diagram illustrating an energy management system in a home network interworking with a smart grid in accordance with an embodiment of the present invention.

Referring to FIG. 1, the energy management system in accordance with the embodiment of the present invention includes a power consumption apparatus 10, a power management apparatus 100, a power storage apparatus 200, a power production apparatus 300, a mobile power storage/supply apparatus 400, a smart meter 500, a wireless terminal 600, a power network 1, and a communication network 2.

The power network 1 as a smart grid applied to the embodiment of the present invention employs a smart grid technology in which power is combined with communication.

The communication network 2 as a wired or wireless communication network may include a wired broadband network such as the Internet, a wired local area network, a wireless broadband network such as Wireless Broadband (WiBro) or Wideband Code Division Multiple Access (WCDMA), and a wireless local area network such as Wi-Fi.

The power consumption apparatus 10 may include one or more household power consumption appliances, such as, an air conditioner, an electric heater, a refrigerator, a washing machine, a lighting device, and a heating device. The power consumption apparatus 10 transmits the amount of power metered for each of appliances to the power management apparatus 100 via the communication network 2.

The power management apparatus 100 corresponds to a means of managing power according to a power management algorithm in the home network interworking with the smart grid. The power management apparatus 100 may achieve energy management function for efficient power usage in point of consumers by taking into consideration a real-time power price in the home network and demand response information of a main power grid.

In detail, the power management apparatus 100 integrally manages the power storage apparatus 200, the power production apparatus 300, the mobile power storage/supply apparatus 400 such as an electric vehicle, and the power consumption apparatus 10, which exist in a home environment. In addition, the power management apparatus 100 provides an environment for efficient energy usage by measuring the power consumption of the power consumption apparatus 10, managing the operational status of the power consumption apparatus 10, and considering a lifestyle plan of a user and the power statuses of household smart devices.

Further, the power management apparatus 100 optimizes the power consumption of digital home power consumption devices by linking a control of the operational mode of the power consumption apparatus 10 with the control of storage/output of the power storage apparatus 200 and the control of the mobile power storage/supply apparatus 400, based on power information collected from the power consumption apparatus 10, a real-time power price, power status information received from the power storage apparatus 200 and the power production apparatus 300, status information of the mobile power storage/supply apparatus 400, information about a lifestyle pattern and schedule plan of a user, and real-time price pattern information.

The power storage apparatus 200 either stores power for home use or supplies the corresponding power to the power consumption apparatus 10 under a power management control performed by the power management apparatus 100.

The power production apparatus 300 transmits information about the status of its power production to the power management apparatus 100 via the communication network 2 such that the information about the power production status is used for the power management of the power management apparatus 100.

The mobile power storage/supply apparatus 400, e.g., an electric vehicle, is provided with a module for managing its power status and transmits the power status to the power management apparatus 100. The smart meter 500 transmits real-time price information and demand response information provided from a power service provider to the power management apparatus 100 via the communication network 2 such that the pieces of information are used when the power management apparatus 100 controls the storage or supply of power and the power consumption.

The wireless terminal 600 is a means for inputting the usage plan of an electric vehicle as a mobile power apparatus, the schedule of a home power consumer, and the like. For example, an apparatus for displaying home energy information and inputting control instructions may be used as the wireless terminal 100.

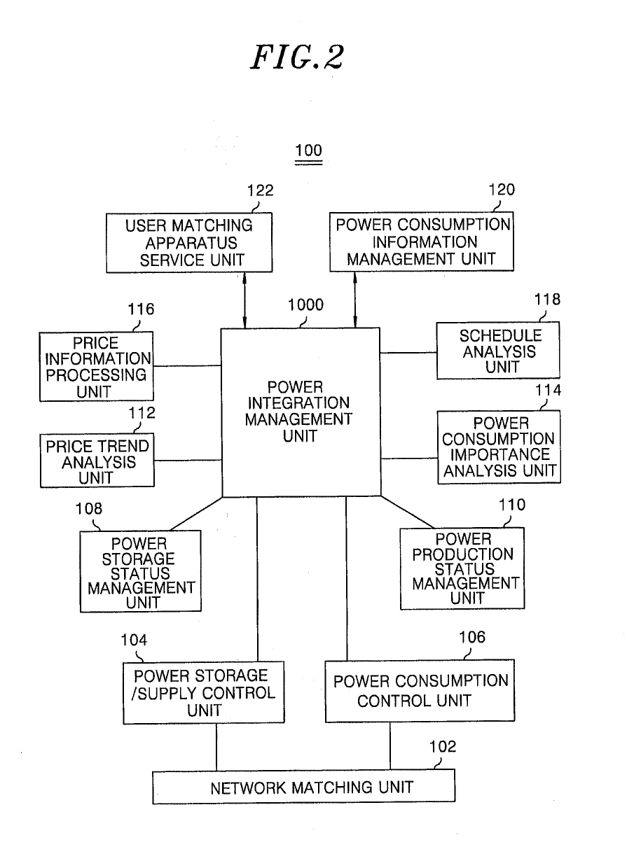

FIG. 2 is a block diagram illustrating the power management apparatus 100 shown in FIG. 1.

Referring to FIG. 2, the power management apparatus 100 includes a network interface unit 102, a power storage/supply control unit 104, a power consumption control unit 106, a power storage status management unit 108, a power production status management unit 110, a price trend analysis unit 112, a power consumption importance analysis unit 114, a price information processing unit 116, a schedule analysis unit 118, a power consumption information management unit 120, a user matching apparatus service unit 122, and a power integration management unit 1000.

The network interface unit 102 transmits an instruction, which is given by the power integration management unit 1000, to collect or control power information to outside by using a wired and wireless communication networking function of the communication network 2.

The power storage/supply control unit 104 controls and manages the storage/supply of power to/from the mobile power storage/supply apparatus 400, e.g., an electric vehicle by using control and management information extracted from the power integration management unit 1000 based on information obtained from the analysis performed by internal functional modules and information received via the communication network 2, e.g., the power status from the electric vehicle.

The power consumption control unit 106 controls the power consumption of the power consumption apparatus 10 by using the control information generated by the power integration management unit 1000.

The power storage status management unit 108 manages the amount of power to be stored in the power storage apparatus 200 used in a home and the power storage apparatus 200 itself, and further manages the storage/supply of power to/from the power storage apparatus 200.

The power production status management unit 110 manages a real-time power production status transmitted from the power production apparatus 300 used in the home, and transmits the managed real-time power production status to the power integration management unit 1000 so that the real-time power production status can be used as energy management information.

The price trend analysis unit 112 understands the trends inherent in the real-time price fluctuations by analyzing real-time price information which is received from a utility service provider via the smart meter 500, and estimates the directionality of price in the future by performing comparison and analysis.

The power consumption importance analysis unit 114 analyzes the importance of the power consumption apparatus 10 used in the home so that the analyzed importance can be used as information for determining an appliance to be controlled (for example, an appliance to be turned on or turned off) based on the price and a policy.

The price information processing unit 116 stores and manages price information received from the utility service provider. The price information processing unit 116 functions as a database which is referred to for previous price information by the price trend analysis unit 112.

The schedule analysis unit 118 analyzes and integrally manages schedules of respective family members, which are inputted through the wireless terminal 600 used in the home via the communication network 2. The schedules are inputted to the power integration management unit 1000 for the purpose of energy management.

The power consumption information management unit 120 monitors and manages the power consumption of all the power consumption apparatus 10 used in the home. Such information on the power consumption of the power consumption apparatus 10 is also inputted to the power integration management unit 1000 for the purpose of energy management.

The user matching apparatus service unit 122 provides a function of managing various types of services provided from the power management apparatus 100.

The power integration management unit 1000 receives information from the above-described units within the power management apparatus 100 and controls the power storage apparatus 200 and the mobile power storage/supply apparatus 400 in the home environment and controls the power consumption of the power consumption apparatus 10 according to a home power management algorithm.

The above-described power management apparatus 100 may include apparatuses which provide a computing environment available in various home environments, for example, a home server system, a set-top box, a wall pad, and a home gateway, which are used for a digital home service.

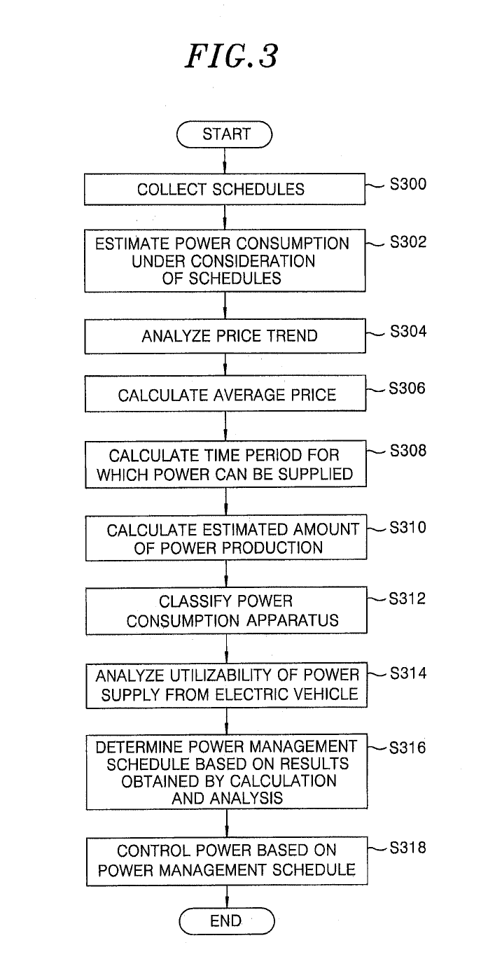

FIG. 3 is a flowchart exemplarily illustrating a power management method in a home network interworking with a smart grid in accordance with the embodiment of the present invention. In FIG. 3, a process of the power management apparatus 100 managing, e.g., the power of the power storage apparatus 200, the mobile power storage/supply apparatus 400 and the power consumption apparatus 10 is described.

As shown in FIG. 3, the power management apparatus 100 collects schedule plans of home users by using the schedule analysis unit 118 at step S300, and estimates power consumption in a home under consideration of the schedule plans of the home users at step S302.

Thereafter, the power management apparatus 100 analyzes trends inherent in the real-time price fluctuations by using the price trend analysis unit 112 based on real-time price information provided from a utility service provider, thereby estimating the directionality of the real-time price fluctuations at step S304.

Next, the power management apparatus 100 calculates an average price for a long time period and for a short time period by using the price information processing unit 116 based on the provided real-time price information at step S306.

Subsequently, the power management apparatus 100 calculates a time period for which power can be supplied from the power storage apparatus 200 based on power storage status information of the power storage status management unit 108 at step S308.

At step S310, the power management apparatus 100 calculates an estimated amount of power to be produced by the power production apparatus 300 based on power production status information of the power production status management unit 110. The estimated amount of power may be used in a detailed power management algorithm.

Thereafter, the power management apparatus 100 classifies the power consumption apparatus 10 based on the importance thereof analyzed by the power consumption importance analysis unit 114 at step S312, and analyzes utilizability of the power supply from the mobile power storage/supply apparatus 400, e.g., the electric vehicle while taking into consideration an operational plan of the electric vehicle at step S314.

Based on the information obtained by the above-described calculation and analysis, the power management apparatus 100 controls and manages power operations of the electric vehicle, the power storage apparatus 200 and the power consumption apparatus 10, thereby determining a power management schedule in step S316. Finally, the power management apparatus 100 controls power for each of the apparatuses according to the power management schedule such that efficient energy usage can be achieved in point of consumers at step S318.

The power management schedule in accordance with the embodiment of the present invention may be illustrated as follows.

First, the power integration management unit 1000 of the power management apparatus 100 uses power stored in the power storage apparatus 200 when the real-time price is higher than the average price for a long time period or for a short time period, and stores power in the power storage apparatus 200 when the real-time price is lower than the average price for the long time period or for the short time period.

Second, the power integration management unit 1000 stores power in the power storage apparatus 200 when an increase in price is predicted, and supplies power from the power storage apparatus 200 to the power consumption apparatus 10 when a decrease in price is predicted.

Third, in a period where the price is temporarily higher than the average price for a short time period, the power integration management unit 1000 may determine whether to use power of the power storage apparatus 200 or not based on a time period for which power can be supplied from the power storage apparatus 200.

Fourth, the power integration management unit 1000 uses power produced in the power production apparatus 300 when an estimated amount of power to be produced by the power production apparatus 300 is sufficient and a real-time power price is high, and, otherwise, stores the produced power of the power production apparatus 300 to the power storage apparatus 200.

Fifth, the power integration management unit 1000 may determine whether to supply or block power to the power consumption apparatus 10 based on the importance of the power consumption apparatus 10 derived from the power consumption importance analysis unit 114 when a real-time power price is high.

Sixth, the power integration management unit 1000 may determine whether to charge an electric vehicle with power or to use the power of the electric vehicle depending on both an operational plan of the electric vehicle and whether a trend of price fluctuations is to increase or decrease.

Based on the power management schedule determined as described above, the power management apparatus 100 provides controls and manages the power of the power storage apparatus 200, the electrical vehicle as the mobile power storage/supply apparatus 400.

The present invention in accordance with the above-described embodiments may provide a power management technology in a home network interworking with a smart grid, which may enable consumers to efficiently use and manage energy in such a way as to perform integrated management by performing the function of monitoring and controlling the status of power consumption of power consumption device, performing the function of managing and controlling the status of the power storage/production apparatus, and by taking into consideration the lifestyle pattern and plan of a consumer and real-time power price.

In accordance with the present invention, the present invention may provide an environment which enables consumers to efficiently use and manage energy in such a way as to perform integrated management by performing the function of monitoring and controlling the status of power consumption of power consumption device, performing the function of managing and controlling the status of the power storage/production apparatus, and by taking into consideration the lifestyle pattern and plan of a consumer and real-time power price.

While the invention has been shown and described with respect to the embodiments, it will be understood by those skilled in the art that various changes and modification may be made without departing from the scope of the invention as defined in the following claims.

What is claimed is:

1. An energy management system in a home network interworking with a smart grid, comprising:
a power management apparatus for managing power consumption of a power consumption apparatus within the home network and managing a power usage based on a real-time price in the home network and demand response information in a power network;
a power storage apparatus for storing power therein or supplying power stored therein to the power consumption apparatus under a control of the power management apparatus;
a power production apparatus for transmitting status information of its power production to the power management apparatus such that the information is used for power management of the power management apparatus;
a mobile power storage/supply apparatus for transmitting its power status to the power management apparatus such that the power status is used for power management of the power management apparatus;
a smart meter for transmitting the real-time price and the demand response information to the power management apparatus; and
a wireless terminal for inputting a usage plan of the mobile power storage/supply apparatus and a schedule of a home power consumer.

2. The energy management system of claim 1, wherein the mobile power storage/supply apparatus includes an electric vehicle.

3. A power management apparatus in a home network interworking with a smart grid, comprising:
a power integration management unit for controlling a power storage apparatus and a mobile power storage/supply apparatus, and one or more power consumption apparatuses in the home network according to a home power management algorithm;
a network interface unit for transmitting an instruction, which is given by the power integration management unit, of collecting or controlling power information to outside via a wired or wireless communication network;
a power storage/supply control unit for performing control and management such that power is stored to or supplied from the mobile power storage/supply apparatus based on information received through the network interface unit;
a power consumption control unit for controlling power consumption of the power consumption apparatuses based on power control information generated by the power integration management unit;
a power storage status management unit for managing an amount of power stored in the power storage apparatus, and managing a storage of power to or a supply of power from the power storage apparatus; and
a power production status management unit for managing real-time power production status of a power production apparatus to transmit the managed real-time power production status to the power integration management unit.

4. The power management apparatus of claim 3, further comprising:
a price trend analysis unit for understanding trends inherent in real-time price fluctuations by analyzing real-time price information which is received through the network interface unit;
a power consumption importance analysis unit for analyzing importance of each of the power consumption apparatuses to transmit the analyzed importance to the power integration management unit;
a price information processing unit for storing and managing the real-time price information;
a schedule analysis unit for analyzing schedules of respective family members which are inputted for power management;
a power consumption information management unit for monitoring a power consumption of each of the power consumption apparatuses; and
a user matching apparatus service unit for providing a function of managing services provided from the power management apparatus.

5. The power management apparatus of claim 4, wherein the price trend analysis unit estimates a directionality of a power price by performing comparison and analysis of the real-time price fluctuations.

6. The power management apparatus of claim 4, wherein power integration management unit determines whether to turn on or off each of the power consumption apparatuses based on the power price.

7. A power management method in a home network interworking with a smart grid in which a power network and a communication network coexist, the method comprising:
collecting schedule plans of users within the home network;
estimating power consumption in a home under consideration of the collected schedule plans;
estimating a directionality of real-time price fluctuations by analyzing a price trend based on real-time price which is received via the communication network;
calculating an average price for a long time period and for a short time period based on the real-time price;
calculating a time period for which power can be supplied from a power storage apparatus connected to the power network;
calculating an estimated amount of power to be produced by a power production apparatus connected to the power network;
classifying one or more power consumption apparatuses connected to the power network depending on importance of each of the power consumption apparatuses;
analyzing utilizability of a power supply from a mobile power storage/supply apparatus connected to the power network while taking into consideration an operational plan of the mobile power storage/supply apparatus;
determining a power management schedule by controlling and managing a power operation of the power storage apparatus, the power consumption apparatuses, and the mobile power storage/supply apparatus; and
providing controlling power for each of power consumption apparatuses, the power storage apparatus, power production apparatus and the mobile power storage/supply apparatus according to the determined power management schedule.

8. The power management method of claim 7, wherein said determining the power management schedule includes:
using power stored in the power storage apparatus when the real-time price is higher than the average price for the long time period or the short time period, and
storing power in the power storage apparatus 200 when the real-time price is lower than the average price for the long time period or for the short time period.

9. The power management method of claim 7, wherein said determining the power management schedule includes:
storing power in the power storage apparatus when a price is predicted to increase based on the directionality of the real-time price fluctuations; and
supplying power stored in the power storage apparatus to the power consumption apparatuses when the price is predicted to decrease based on the estimated directionality of the real-time price fluctuations.

10. The power management method of claim 7, wherein said determining the power management schedule includes:
determining, in a period where a price is temporarily higher than the average price of the short time period, whether to use power of the power storage apparatus or not based on the calculated time period for which power can be supplied from the power storage apparatus.

11. The power management method of claim 7, wherein said determining the power management schedule includes:
using power produced in the power production apparatus when the estimated amount of power to be produced by the power production apparatus is sufficient and the real-time price is high; and otherwise, storing the power produced in the power production apparatus to the power storage apparatus.

12. The power management method of claim 7, wherein said determining the power management schedule includes:
determining whether to supply or block power to the power consumption apparatuses based on the importance of the power consumption apparatuses when a real-time power price is high.

13. The power management method of claim 7, wherein the determining the power management schedule includes:
determining whether to charge the mobile power storage/supply apparatus with power or to use power of the mobile power storage/supply apparatus depending on both the operational plan of the mobile power storage/supply apparatus and whether the price trend is to increase or decrease.
